(19) United States
(12) Patent Application Publication
(10) Pub. No.: US 2019/0188475 A1
(43) Pub. Date: Jun. 20, 2019

(54) SOCIAL MEDIA SYSTEMS AND METHODS

(71) Applicant: SpokeHub, Inc., Durham, NC (US)

(72) Inventors: John McAdory, Cary, NC (US); Robert Hartsfield, Chapel Hill, NC (US); Kerianne Enderline, Holly Springs, NC (US); John York, Charlotte, NC (US); Richard Berryman, Durham, NC (US); Andrew Jason Ivory, Raleigh, NC (US); Benjamin Mark Schell, Raleigh, NC (US); Kristal Michelle York, New Milford, CT (US); Erik Burckart, Raleigh, NC (US)

(73) Assignee: SpokeHub, Inc., Durham, NC (US)

(21) Appl. No.: 16/222,654

(22) Filed: Dec. 17, 2018

Related U.S. Application Data
(60) Provisional application No. 62/599,680, filed on Dec. 15, 2017.

(51) Int. Cl. G06K 9/00; H04W 4/02; H04W 4/21; G06F 3/0481

(52) U.S. Cl. CPC G06K 9/00671; H04W 4/023; H04N 5/44504; G06F 3/0481; H04W 4/21

(57) ABSTRACT

A method and system for providing augmented reality experiences unique to a user's interface format is provided. The method includes receiving from a mobile device identification of an interface format from which a camera view is opened in the mobile device. The method further includes identifying a trigger within the camera view for launching one version of an augmented reality experience; identifying, from the plurality of versions of the augmented reality experience, the one version that uniquely corresponds to the interface format; and providing to the mobile device for display the one version.

### CROSS REFERENCE TO RELATED APPLICATIONS

This application claims the benefit of U.S. Provisional Application No. 62/599,680 filed Dec. 15, 2017, which is herein incorporated by reference in its entirety.

### TECHNICAL FIELD

The present invention relates generally to systems and methods for launching unique augmented reality experiences based on an interface format of a mobile device. Specifically, the various versions of the augmented reality experiences launched are enabled by the same environmental trigger element, the particular version launched being dependent upon the social media application's interface format immediately prior to launch.

### BACKGROUND

Social media applications and services are ubiquitous. Most social media applications permit users to share content with other users in a public forum or through the interfaces or pages of individuals or groups. Further, augmented reality technology is a growing field, capable of providing unique experiences for users and branding for advertisers. While some augmented reality technologies permit integration with social media applications, there remains a need for launching specifically-tailored augmented reality versions within social media applications based on the interface format from which the augmented reality experience is launched.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

According to at least one embodiment, a system is provided including: at least one processor; and at least one storage medium for storing instructions for execution by the at least one processor for causing the system to: receive from a mobile device identification of an interface format from which a camera view is opened in the mobile device; identify a trigger within the camera view for launching one or more of a plurality of augmented reality experiences; identify, from the plurality of augmented reality experiences, one or more versions that correspond to the interface format; and provide to the mobile device for display of the identified one or more augmented reality experience versions.

According to at least another embodiment, a method is provided including receiving from a mobile device identification of an interface format from which a camera view is opened in the mobile device; identifying a trigger within the camera view for launching one or more of a plurality of augmented reality experiences; identifying, from the plurality of augmented reality experiences, the one or more augmented reality experiences that correspond to the interface format; and providing to the mobile device for display the identified one or more augmented reality experiences.

According to at least one embodiment, the system or method further including the system being caused to receive or the method receiving from the mobile device a location, wherein the identified one or more augmented reality experiences further corresponds to the location.

According to at least one embodiment, wherein the location is recognition within a geo-fenced virtual perimeter.

According to at least one embodiment, wherein the location is recognition by a low energy transmission from a positioned beacon.

According to at least one embodiment, wherein the trigger is three dimensions of a moving in motion.

According to at least one embodiment, wherein the trigger is a time or score of a scoreboard at a sporting event.

According to at least one embodiment, the system or method further including the system being caused to receive or the method receiving from the mobile device a user quality of a user operating the mobile device, wherein the identified one or more augmented reality experiences further corresponds to the user quality.

According to at least one embodiment, wherein the user quality is an gamification score based on the user's history with the system.

According to at least one embodiment, the system or method further including the system being caused to provide or the method providing to the mobile device for display a second interface format following the display of the identified one or more augmented reality experiences.

The foregoing and other aspects of the present invention will now be described in more detail with respect to other embodiments described herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 depicts a system in communication with a plurality of mobile devices, each hosting a mobile application according to at least one embodiment of the present disclosure.

FIG. 2 is a screenshot of the mobile application having a plurality of interface formats according to at least one embodiment of the present disclosure.

FIG. 3 is a screenshot of one of the plurality of interface formats according to at least one embodiment of the present disclosure.

FIG. 4 is a screenshot of the settings page for editing an interface format according to at least one embodiment of the present disclosure.

FIG. 5 is a screenshot of the creation page for creating a secondary interface format according to at least one embodiment of the present disclosure.

FIG. 6 is a screenshot of an interface format displaying the secondary interface formats nested therewithin according to at least one embodiment of the present disclosure.

FIG. 7 is a screenshot of the camera data depicting a trigger following a launch from an interface format according to at least one embodiment of the present disclosure.

FIG. 8 is a screenshot of the camera data with an augmented reality experience version overlay over the trigger according to at least one embodiment of the present disclosure.

FIG. 9 is a screenshot of messaging within an interface format following the viewing of an augment reality experience version according to at least one embodiment of the present disclosure.

FIG. 10 is a screenshot of the mobile application having a plurality of interface formats according to at least one embodiment of the present disclosure.

FIG. 11 is a screenshot of the camera data depicting a trigger following a launch from an interface format, along with an instructional message, according to at least one embodiment of the present disclosure.

FIG. 12 is a screenshot of the camera data with an augmented reality experience version overlay extending from the trigger according to at least one embodiment of the present disclosure.

FIG. 13 is a screenshot of the camera data with an augmented reality experience version overlay extending from the trigger during reposition of the mobile device relative to the trigger according to at least one embodiment of the present disclosure.

FIG. 14 depicts steps of a method of launching an augmented reality experience version from an interface format according to at least one embodiment of the present disclosure.

FIG. 15 depicts a decision tree of triggering an experience and launching a version according to at least one embodiment of the present disclosure.

### DETAILED DESCRIPTIONS

The following description and drawings are illustrative and are not to be construed as limiting. Numerous specific details are described to provide a thorough understanding of the disclosure. However, in certain instances, well-known or conventional details are not described in order to avoid obscuring the description.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any, exemplified term. Likewise, the disclosure is not limited to various embodiments given in this specification.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by presently disclosed subject matter.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

As will be appreciated by one of ordinary skill in the art in view of this disclosure, the invention may be embodied as an apparatus (including, for example, a system, machine, device, computer program product, or any other apparatus), method (including, for example, a business process, computer-implemented process, or any other process), a system, a computer program product, and/or any combination of the foregoing. Accordingly, embodiments of the invention may take the form of an entirely software embodiment (including firmware, resident software, micro-code, etc.), an entirely hardware embodiment, or an embodiment combining software and hardware aspects that may generally be referred to herein as a system 200, or social media system, 200. Furthermore, embodiments of the invention may take the form of a computer program product having a computer-readable storage medium having computer-executable program code embodied in the medium.

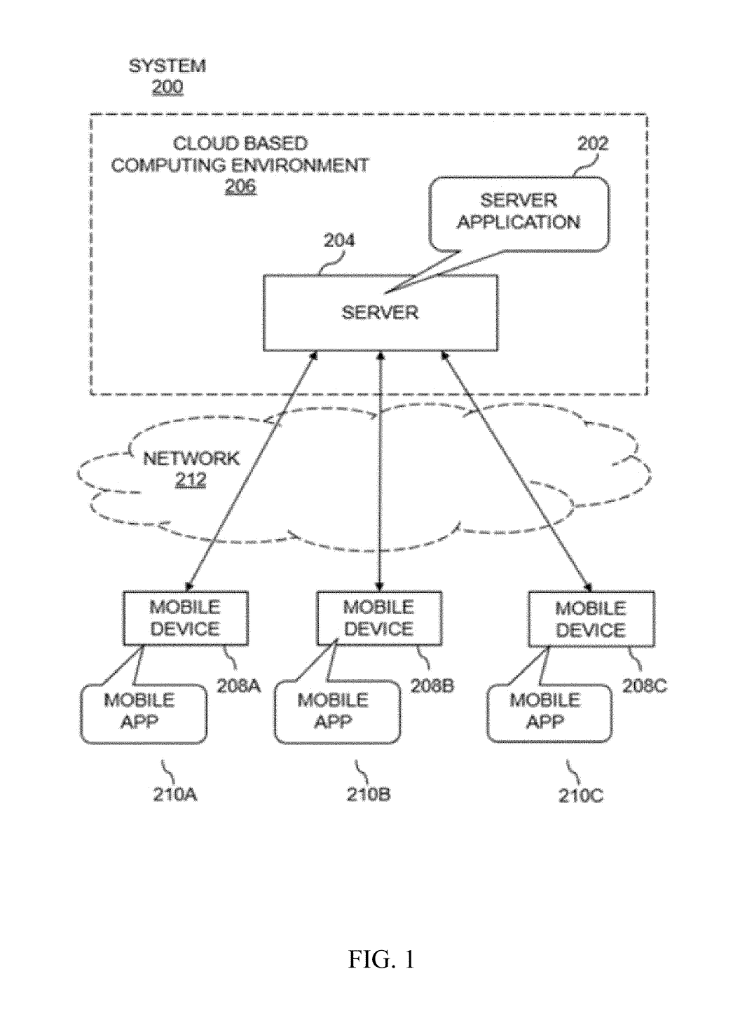

As is depicted according to at least one embodiment in FIG. 1, the system 200 is implemented as a client/server architecture wherein a plurality of users 1 may communicate using their computing device with a central hub (e.g. server). The server may be a physical server or a virtual server. In other embodiments the server may be located on a company premise, or located in any other type of datacenter. The server may also be configured as a plurality of physical servers and/or virtual servers. In some embodiments, a server may provide the virtual server and may be implemented as a separated operating system (OS) running on one or more physical (i.e. hardware implemented) servers. Any applicable virtual server may by be used for the server function. The server may be implemented within a cloud computing data center environment or the like.

A computing device may be a fixed device or a mobile device. For example, a fixed device may be an interactive kiosk, a personal computer, or the like. A mobile device may be any computing device capable of being transported easily from a one location to another location without undue difficulty and one that is capable of functional connection with a remote server regardless of its location. For example a mobile device may be a smart phone, a tablet, a personal digital assistant, a laptop, or the like. In general, a computing device as used with the system 200 may be any computing device providing a user 1 input, display, and connectivity to one or more servers over a personal area network (PAN), a local area network (LAN) and/or a wide area network (WAN). The PAN may include Bluetooth® or Universal Serial Bus (USB). The LAN may include any combination of wired Ethernet and/or Wi-Fi access points. The WAN may include the Internet and/or another wide area private network. The WAN may also include any combination of 2G, 3G, 4G, and 5G networks. In some embodiments the WAN may include Data Over Cable Service Interface Specification (DOCSIS) networks and/or fiber networks such as passive optical networks (PONs). Access to the one or more servers may also be provided via a virtual private network (VPN) within any of the previously described networks.

The system 200 may communicate with the computing devices via an app or through a website. In use, a user 1 first downloads the app or goes to the website to register and log onto the system 200. In some embodiments, the user 1 registers by creating a unique ID and/or password that identifies the user 1 in the system 200. The system 200 may be combined with mobile technology, such that a user 1 may enter the system 200 with a mobile device by simply going to the website and/or opening the app.

Th social networking system 200 may be in communication with a plurality of mobile devices 208, each hosting, or providing access to, a mobile application or website 210 according to at least one embodiment of the system 200. The system 200 may include an data manager 201 for receiving, retreiving and/or storing data from the various mobile devices 208 and/or third party sources having information relevant to the user 1. The data manger 201 may also analyze the received, retrieved and/or stored data for making determinations.

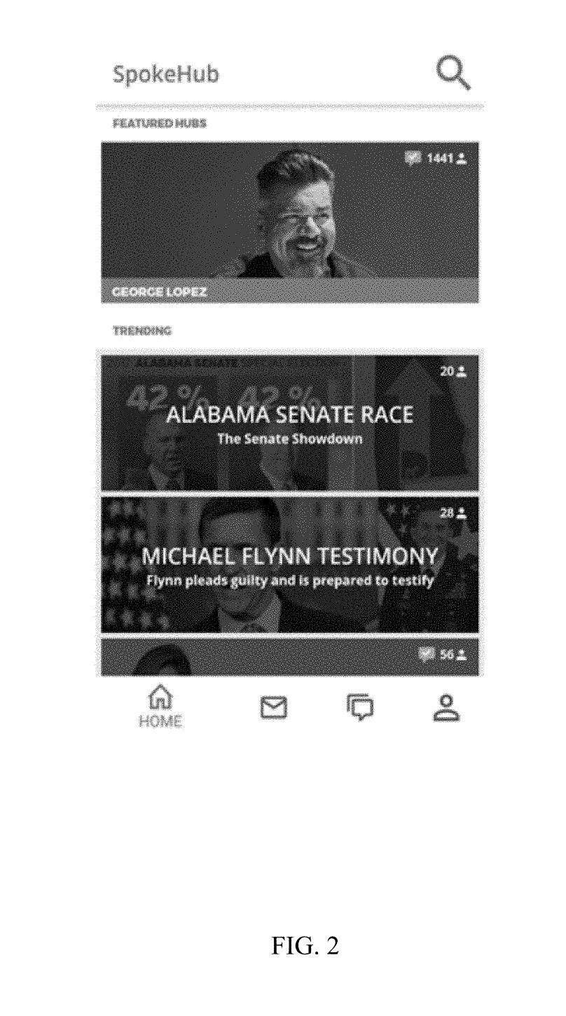

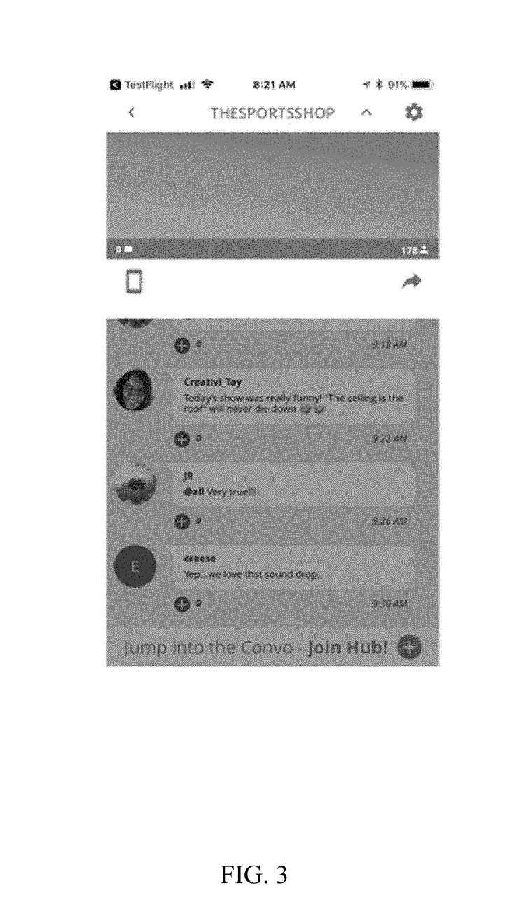

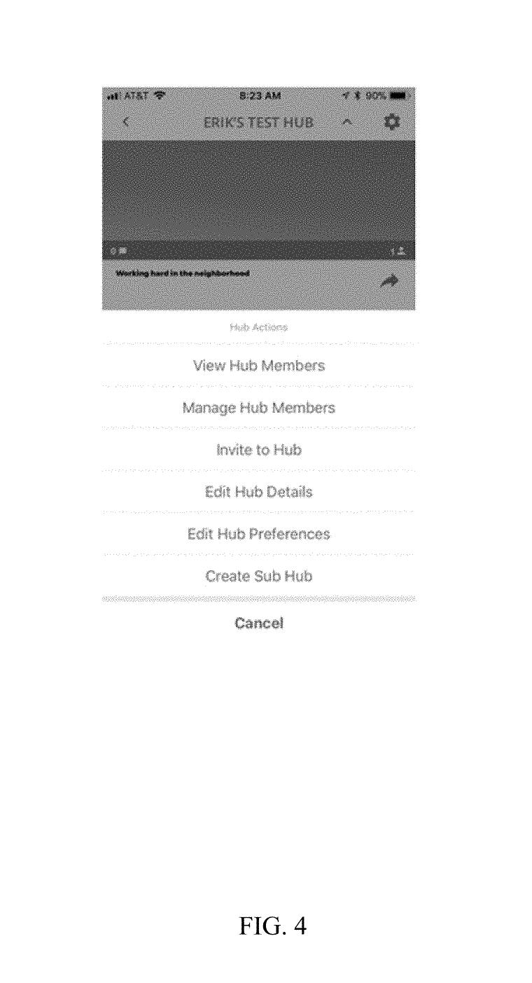

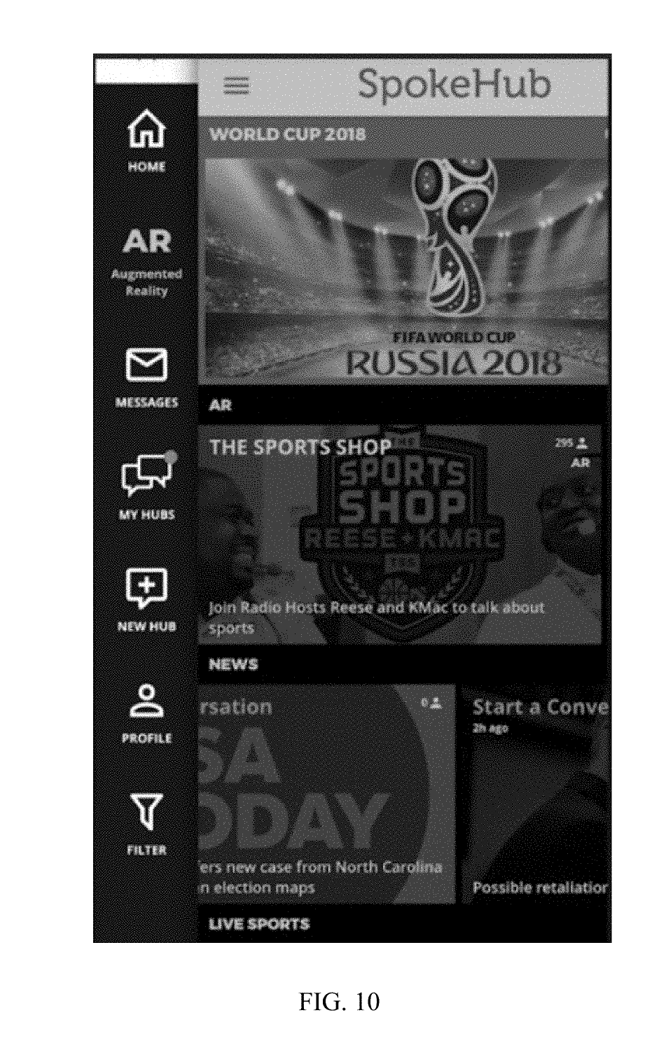

Hub. The mobile application or web site 210 may display or enable access to a plurality of hubs 300, as shown in FIGS. 2 and 10. Each hub 300 is a unique interface format (see, e.g., FIG. 3). The interface format or hub 300 may include one or more of the following features provided to the mobile device(s) for display: image, font, background color, border, title and/or topic 304, each of which may be altered by a user 1 and/or the system 200 (see, e.g., FIG. 4). The topic 304 may include one or more of the following: celebrities, current events, sports, sport teams, colleges, social issues, locations, places, concepts and lifestyle interests. Content 306 may be submitted, received and/or posted within each hub 300 for viewing or display within the system 200. Content 306 may take many forms, including one or more of the following: text, images, graphic interchange formats (GIFs), video, sound recordings and other communication formats.

Each hub 300, and therefore interface format 300, may include a privacy setting 308 for controlling the viewing and/or posting of content 306 by users 1 and/or controlling the notifications to users 1 relating to the hub 300. Each hub 300 may include one or more users 1 identified as members 2 of the hub 300 and one or more users 1 identified as non-members 3 of the hub 300. Member-users 2 may be granted permission to perform certain functions and/or have certain access within the hub 300 of which they are a member which are unavailable to other non-member-users 3. For example, in a publicly available hub 300, a non-member-user 3 may be able to view the content 306 created within the hub 300, but may not be able to effectuate a post of content 306 within the hub 300; a member-user 2 may be able to both view and effectuate a post of content 306 within the hub 300. In a private hub 300, for example, only a member-user 2 may have permission to view the content therein.

The mobile application or website 210 may display a plurality of hubs 300 available to a user 1 according to some embodiments of the disclosed subject matter. Additionally, a hub 300 may be created within the system 200 by receiving a creation request 301. The creation request 301 may be received from a user 1 for creation of the hub 300, thereby forming the features of the hub or interface format 300, the messaging topics 304, and/or the privacy settings 308.

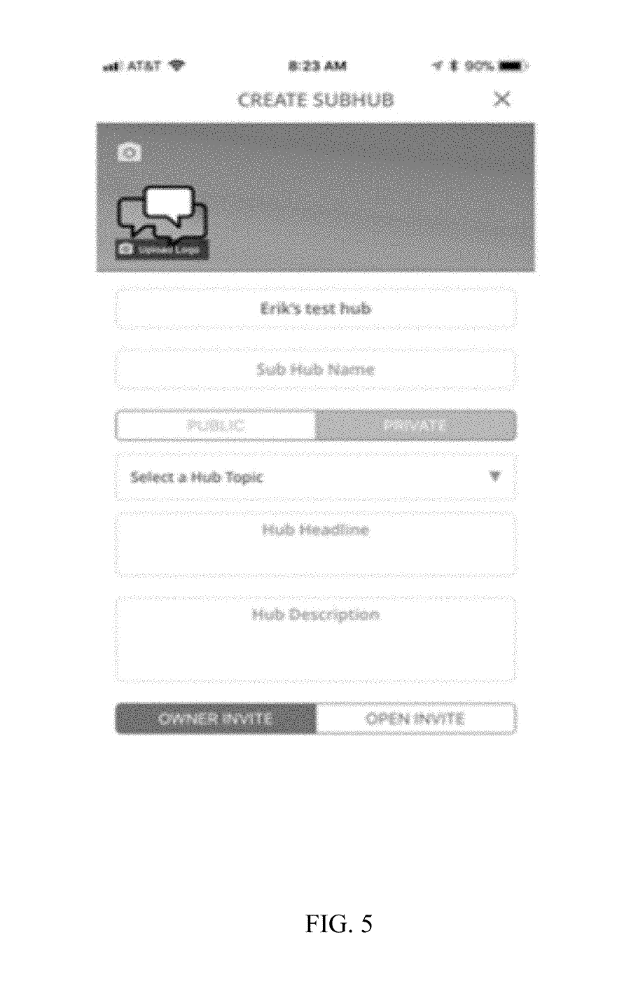

Sub-hub. The system 200 may permit, within one or more hubs 300, the creation of one or more sub-hubs 310 therewithin or thereunder (see e.g., FIG. 5). A sub-hub 310 may have similar qualities as a hub 300 within the system 200. For example, the sub-hub 310 is also a unique user interface format with a unique topic. Content 306 may be submitted, received and/or posted within each sub-hub 310 for viewing or display. Each sub-hub 310 may include a privacy setting 308 for controlling the viewing and/or posting of content 306 by users 1 and/or controlling the notifications to users 1 relating to the sub-hub 310. Each sub-hub 310 may include one or more users 1 identified as members 2 of the sub-hub 310 and one or more users 1 identified as non-members 3 of the hub 310. Member-users 2 may be able to perform certain functions and/or have certain permissions within the hub 310 of which they are a member which are unavailable to other non-member-users 3.

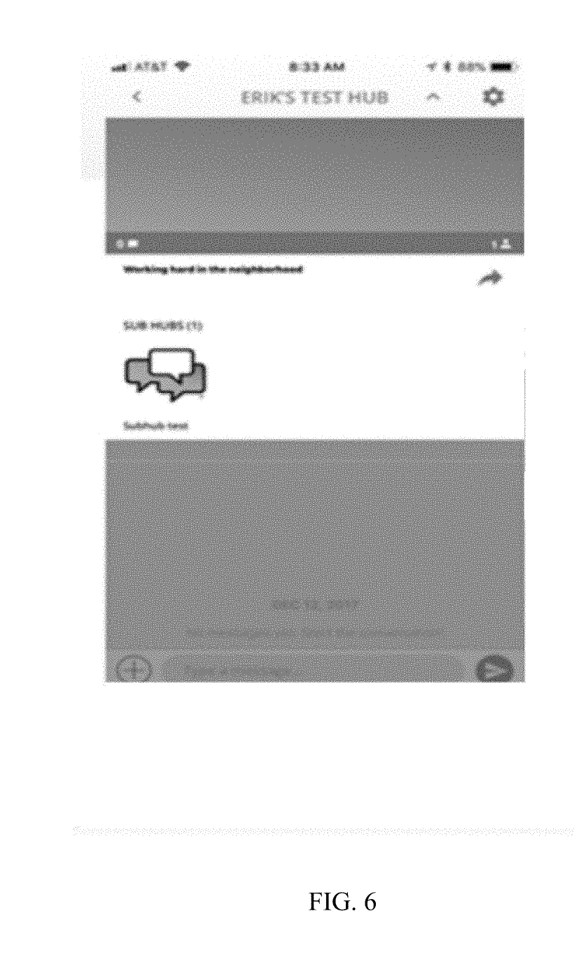

A sub-hub 310 is nested within a hub 300 (or another sub-hub 310) (see, e.g., FIG. 6); member-users 2 of the sub-hub 310 must be member-users of the hub 300 (and/or the parent sub-hub 310). Upon creation of the sub-hub 310, the sub-hub 310 then becomes an active messaging interface 310 within the parent messaging interface hub 300 from which it was created. Further, content 306 posted within a hub 300 (and/or parent sub-hub 310) may be duplicated within a nested or downstream sub-hub 310. Conversely, content 306 posted within a sub-hub 310 would not be duplicated upstream to a parent hub 300 or sub-hub 310.

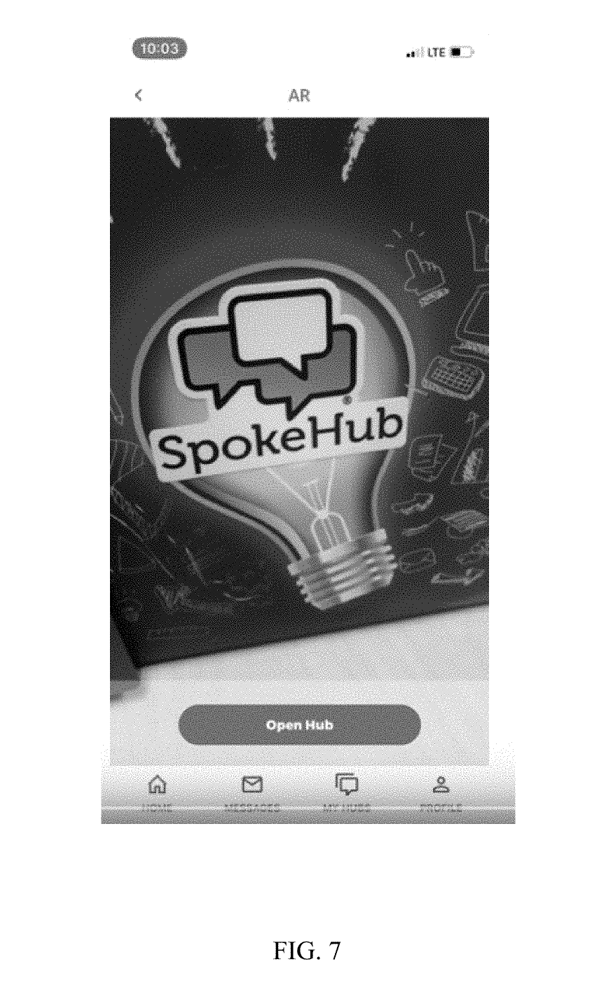

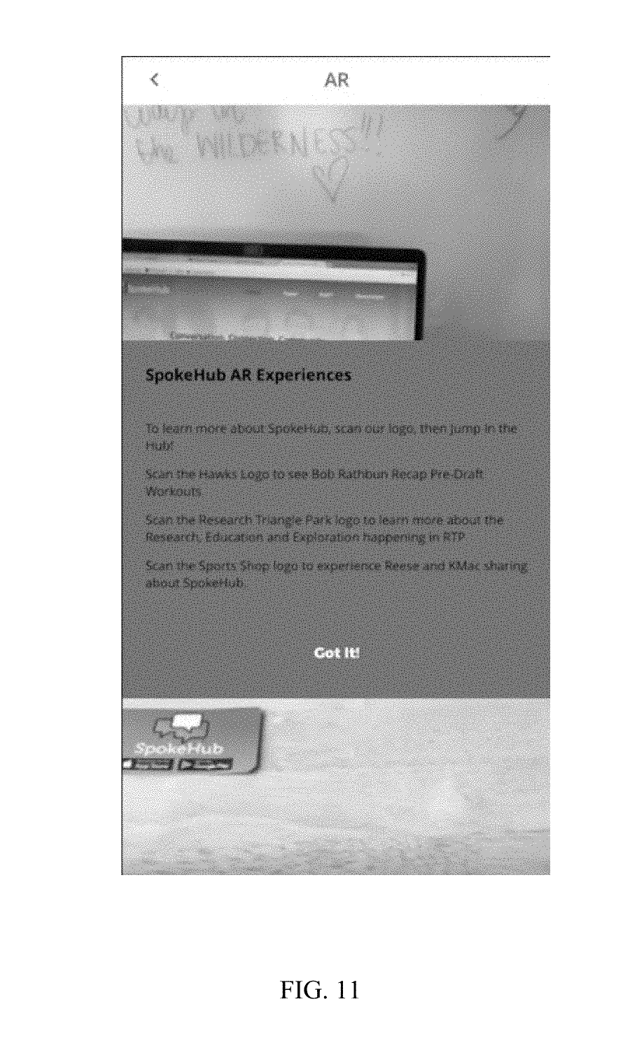

Launch. As is depicted according to at least one embodiment in FIG. 7, the system 200 may enable a launch 320 of an augmented reality (AR) module 312 for depicting camera data 316 at the mobile device 208 and/or any augmented reality experience 340 or version 341 (see also FIG. 11). As used herein, “camera data” refers to the data presented to a display of the mobile device that includes an image stream of image frames provided by the camera of the mobile device. For example, the camera data may include real-time views from the camera of the mobile device. A launch 320 of the AR module 312 may be effectuated from within a hub 300 or sub-hub 310. In alternative embodiments, a launch may be effectuated without a hub 300 or sub-hub 310. The AR module 312 may communicate with other modules of the mobile device 208, such as a camera module 400 and/or lighting module 410. Upon a launch 320 of the AR module 312, the mobile device 208 may depict camera data 316 for surveying an environment 5 for one or more triggers 330.

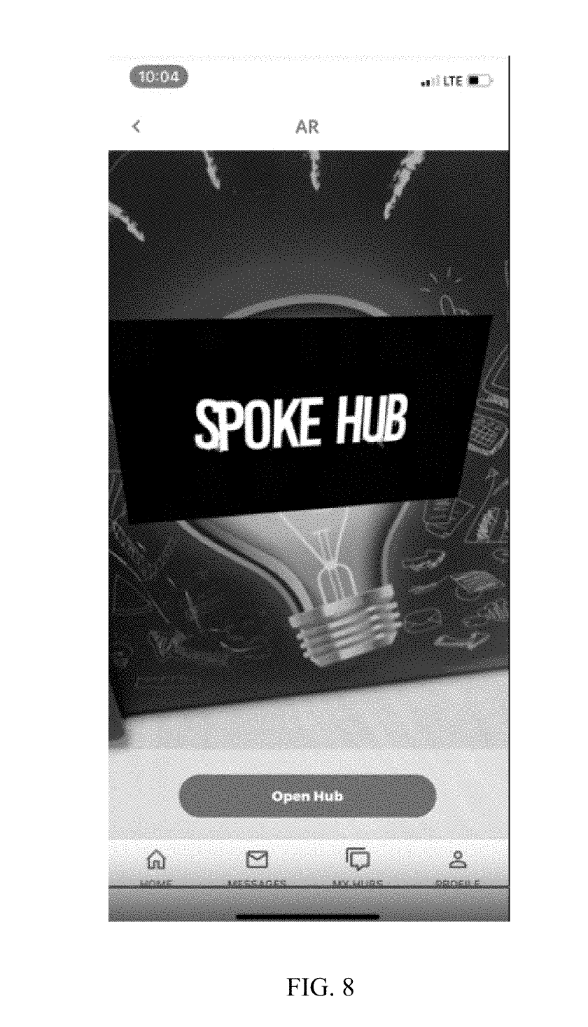

Trigger. According to some embodiments, a trigger 330 may be identified within the environment 5. The trigger 330 may be a two-dimensional or three-dimensional object, the object being a surface, image, code, substance or physical item. The system 200 may store or be populated with a plurality of triggers 330. When the trigger 330 is identified by the AR module 312 as being depicted by the camera data 316 of a mobile device 208, an experience 340, or one or more versions 341 thereof, may be retrieved by the system 200 and communicated to a mobile device 208 for being displayed with the camera data 316 (also known as an overlay) (see, e.g., FIG. 8). In alternative embodiments, the system 200 may retrieve an experience 340, or one or more versions 341 thereof, and communicate the one or more versions 341 to the mobile device 208 for display with the camera data 316.

Experience. Once a trigger 330 is identified, the system 200 may retrieve and/or analyze a package of experiences 340 associated with the trigger 330 for identifying which unique version(s) 341 of the experiences 340 are to be provided to the mobile device 208 for display. The experiences 340 may be augmented reality experiences, and/or versions 341 thereof. As used herein, “augmented reality” refers a composite view including computer-generated elements in association with the camera data. A determination module 314 may be included in the system for parsing through the package of experiences 340 associated with a trigger 330 and determining which version(s) 341 of the experiences 340 correspond to the mobile device 308, the user 1 of the mobile device 208, and/or the interface format 300, 310 from which the AR module 312 was launched. In at least one embodiment, various unique versions 341 of the augmented reality experience 340 may be enabled by the same environmental trigger 330, the particular version 341 launched may be dependent upon the social media application's interface format 300, 310 immediately prior to launch.

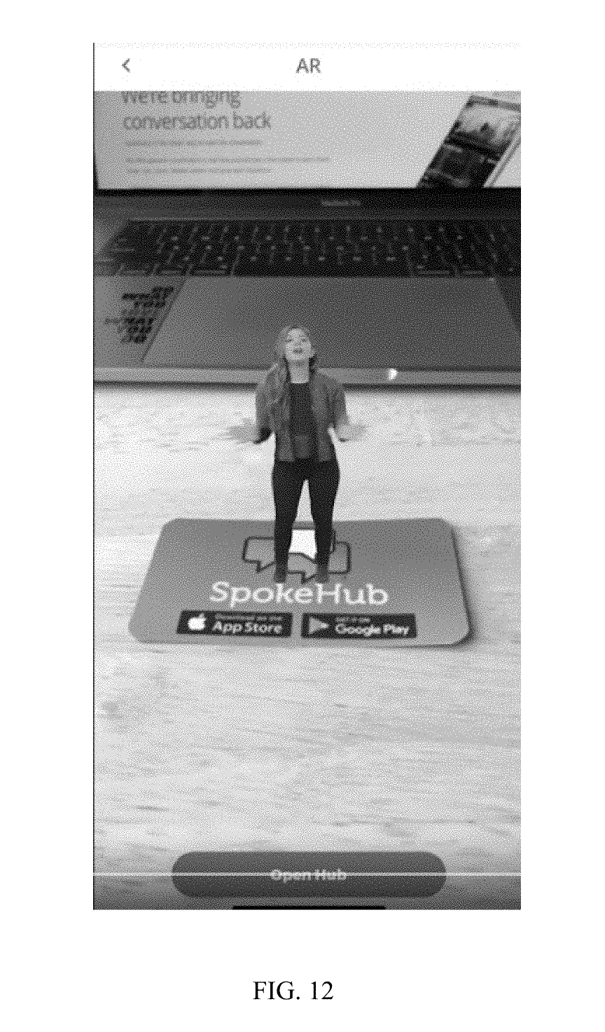

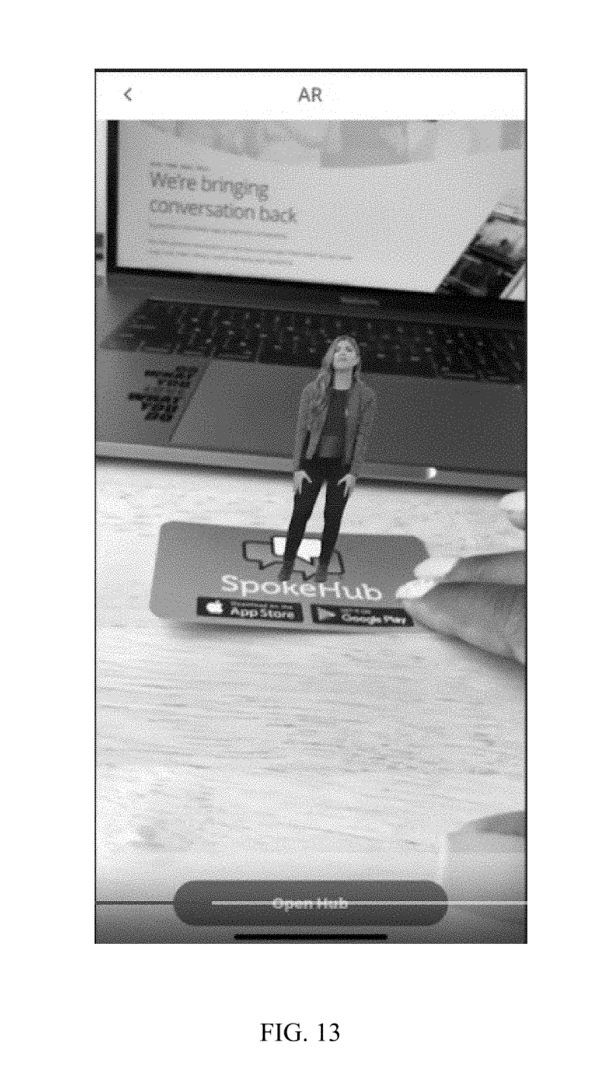

In other embodiments, the same trigger 330 may effectuate the display of one of various unique versions 341 of an experience 340 based on user data 370 associated with the mobile device 208 displaying the version 341 (see, e.g., FIGS. 12 and 13). The version 341 may be displayed over the camera data 316 may be unique to the hub 300 or sub-hub 310 from which the AR module 312 launched, for example. As an example, once a launch 320 of the AR module 312 occurs, a trigger 330, such as Team's logo, may be positioned within the camera data 316 being displayed for identification by the system 200. In one example, if the AR module 312 was launched from the Team's hub 300, a hype experience 340 may be displayed. In an another example, if the AR module 312 was launched from a Brand's sub-hub 310 nested under the Team hub 300, a promo experience 340 featuring the Team and the Brand may be displayed. In such a manner, unique and varied experiences 340 may be effectuated from the same trigger 330 based a launch 320 from a particular hub 300 or sub-hub 310. Other user data 370, location 360, time 380 and/or hub 300 or sub-hub 310 identification may be used to launch a particular version 341 of the experience 340.

The experience 340, or any version 341 thereof, may include any AR effect in the camera view displayed in the user interface, such as one of the following: a two-dimensional image or video, a three-dimensional image or video, an overlay effect, or an overlay audio-visual image or video. For example, if an AR experience 340 is displayed and an image as shown is captured, the AR experience 340 can be included as a part of the image. The experience 340 may be adjusted to fit within a perimeter defined by the trigger 330, or may expand to other areas or positions within the user interface format 300. For example, if an AR overlay is displayed in the camera data 316 and an image as shown in the camera data 316 is captured, the AR overlay would be included as a part of the image.

An experience 340 may be any group of augmented realities. The group of experiences 340 may have a portion which is the same or similar amongst each version 341 of the experiences 340. In some embodiments, the versions 341 of each group of experience 340 each contain exposure to a same brand, company or concept.

In some embodiments, the system 200 may receive a request to add experiences 340 and/or version 341 of an experience 340. The experience 340 and/or version 341 may be correlated to a specific trigger 330, the trigger 330 being previously stored by the system 200 or newly received in association with the experience 340 and/or version 341 add request.

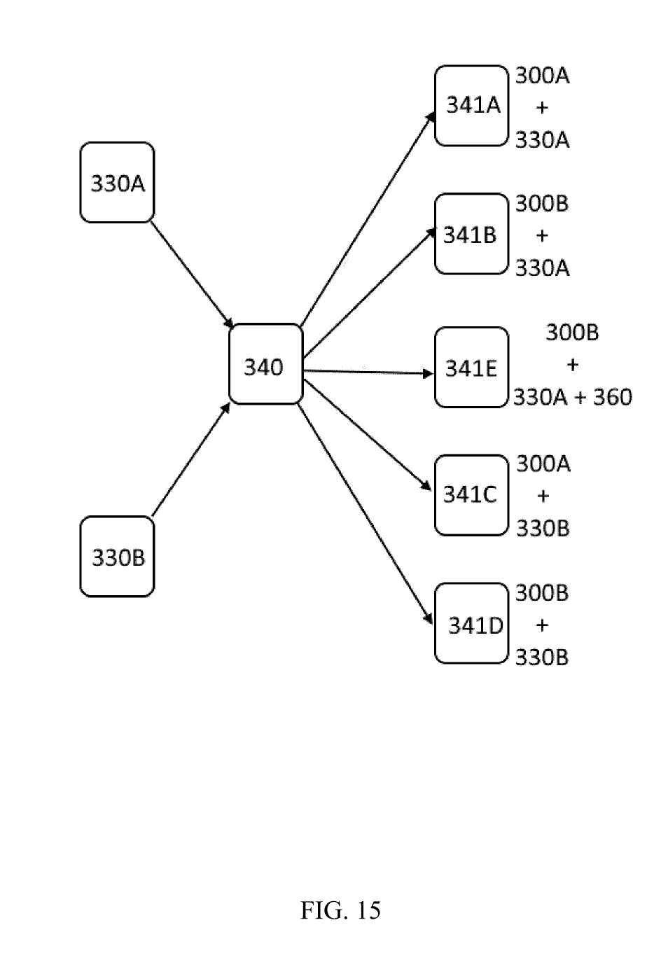

FIG. 15 depicts several paths to launching a particular version 341 of an experience 340 according to one or more embodiments. As is shown in the figure, two separate triggers 330A and 330B may launch the same experience 340. Various versions 341 A-E may be launched 320 from the experience 340. For example, version 341A may be displayed when trigger 330A is identified from camera data 316 within an AR module 312 launched from interface format 330A. But a different version 341 may be displayed if another trigger 330B is 0used (341C) or another interface formats 330B serves as the launch point (341B). If both the trigger 330B and the interface format 300B are different, an fourth version may be launched—341D. In another example depicted, a location 360 in combination with the interface format 300B and the trigger 330A may launch a different version 341E.

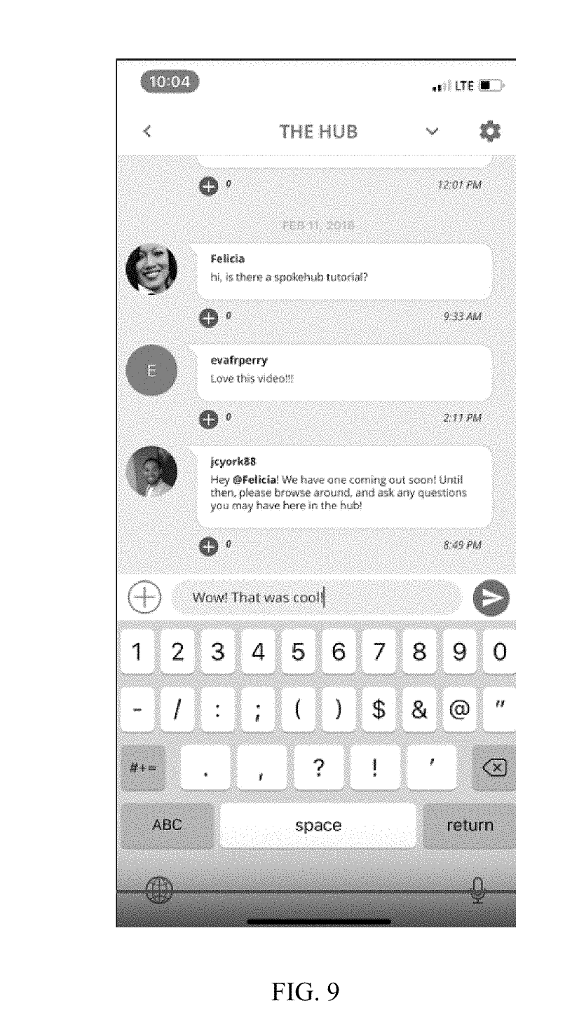

Redirect. During and/or following an experience 340, the system 200 may display an option and/or enable the user interface format 300 to be redirected to a hub 300, sub-hub 310, webpage or other portion of the system 200 or network 212 (see, e.g., FIGS. 8 and 9). Such a redirect 350 may be uniquely and solely accessible from the particular experience 340. For example, a launch 320 of the AR module 312 from a Sport hub 300 enables display of a Football experience 340, which in turn enables a redirect 350 to a private Football sub-hub 310, such that all member-users 2 of the Football sub-hub 310 were each granted original access to the Football sub-hub 310 through the Football experience 340.

Location. A location 360 of a mobile device 208 may be captured and/or stored by the system 200. The location 360 may be identified by the system 200 as being within a particular geo-fence or area, relative to another one or more mobile devices 208, relative to a another device on the network 212, or a GPS location. The location 360 of a mobile device 208 may enable the system to perform a unique launch 320, trigger 330, ARexperience 340 and/or redirect 350.

User Data. The system 200 may capture, store and retrieve user data 370 associated with each user 1. User data may include biographical information, profile settings, hub 300 membership, sub-hub 310 membership, location 360, time and date data 380, historical user interaction with the system 200, real-time user interaction with the system 200, real-time feedback or analytics captured or received by the system 200, and/or any other information captured or retrieved from third party sources relating to the user 1. User data 370 may enable the system to perform a unique launch 320, trigger 330, AR experience 340 and/or redirect 350.

Gamification. Based on usage history within the system 200, a mobile device 208, user 1 and/or interface format 300/310 may accumulate points or badges for unlocking version(s) 341. These points or badges may be included as user data 370.

Real-time feedback or analytics captured or received by the system 200 may include facial or body recognition data captured before, during or after one or more experiences 340. For example, an AR experience 340 may include product branding or messaging, the reaction by the user 1 being useful to capture. In another example, interaction with the AR experience 340 may be permitted by the system 200 through the mobile device can provide product recommendations for a particular user based on products that the user has looked at within a store. In some embodiments, a user 1 may interact with an AR experience 340 based using touch, sound and/or movement communication. on various gestures applied through an interface presenting a camera view. For example, a particular communication, such as a touch communication, can correspond to a particular functionality, such as opening a new sub-hub 310 for the user 1 or directing the user 1 to a webpage.

### Example 1

The launching of an experience 340 may be effectuated by both a trigger 330 and a qualifying location 360. For example, if an experience 340 is launched by viewing a scoreboard trigger 330 depicting halftime, then the particular version 341 of the experience 340 may be based on the location 360 of the mobile device 208 within the qualifying location 360 (e.g., the location relative to a GPS location of the venue, a geofenced boundary for the venue, or within range of a venue-positioned low energy beacon). Such a feature would minimize the ability of users 1 not participating at the qualifying location 360 from launching the particular version of the experience 340.

### Example 2

The launching of an experience 340 may be effectuated by both a trigger 330 and a qualifying time 380. For example, if an experience 340 is launched by viewing a branding trigger 330 depicting a brand logo, then particular version 341 of the experience 340 may be based on the time 380 at which the trigger 330 identified (e.g., nighttime, daytime, summer, winter, 5:30 pm, 5:30 am, 2018, etc.). Such a feature would enable experiences 340 to be tweaked according to the user experience such that the version 341 presented would have maximized the potential for effect.

### Example 3

Additional user data 370 may be created, retrieved and/or stored by the system 200 as experiences 340 are viewed and/or redirects 350 occur. Each of the features and datapoints disclosed herein provide unique branding opportunities and enhanced customer feedback data. For example, a celebrity interface 300, 310 may enable users 1 to scan certain product logos or packaging endorsed by the celebrity, providing users 1 with the opportunity to launch an experience 340 tied to the products and/or celebrity from the interface 300, 310 and subsequently participate in an interaction within a secondary product interface 310 nested within the celebrity interface 300, 310.

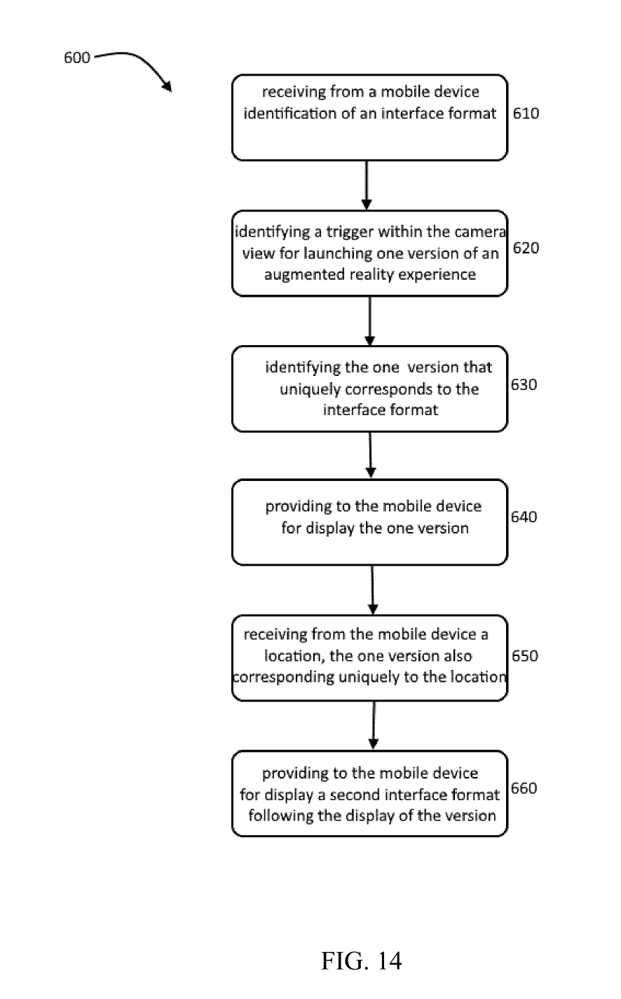

FIG. 14 depicts various steps of a method for launching a version 341 of an experience 340 using the system 200. The method 600 may include: receiving from a mobile device identification of an interface format from which a camera view is opened in the mobile device 610; identifying a trigger within the camera view for launching one version of an augmented reality experience 620; identifying, from the plurality of versions of the augmented reality experience, the one version that uniquely corresponds to the interface format 630; providing to the mobile device for display the one version 640; receiving from the mobile device a location, wherein the one version uniquely corresponds to both the interface format and the location 650; and including providing to the mobile device for display a second interface format following the display of the version 660.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. Programming languages may include, but are not limited to: Ruby, JavaScript, Java, Python, Ruby, PHP, C, C++, C#, Objective-C, Go, Scala, Swift, Kotlin, OCaml, or the like. The program code may execute entirely on the user's computer, partly on the user's computer, as a stand-alone software package, partly on the user's computer, and partly on a remote computer or entirely on the remote computer or server.

Aspects of the present invention are described in the instant specification with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a user” can include a plurality of such users, and so forth. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The invention claimed is:

1. A system comprising:
at least one processor; and
at least one storage medium for storing instructions for execution by the at least one processor for causing the system to:
receive from a mobile device identification of an interface format from which a camera view is opened in the mobile device;
identify a trigger within the camera view for launching one version of an augmented reality experience;
identify, from the plurality of versions of the augmented reality experience, the one version that uniquely corresponds to the interface format;
provide to the mobile device for display the one version.

2. The system of claim 1, being further caused to receive from the mobile device a location, wherein the one version uniquely corresponds to both the interface format and the location.

3. The system of claim 2, wherein the location is a position within a virtual perimeter.

4. The system of claim 2, wherein the location is a distance below a threshold proximity to a beacon.

5. The system of claim 2, wherein the trigger is a time or score of a scoreboard at a sporting event.

6. The system of claim 1, being further caused to receive from the mobile device a user quality of a user operating the mobile device, wherein the one version uniquely corresponds to both the interface format and the user quality.

7. The system of claim 6, wherein the user quality is an gamification score based on the user's history with the system.

8. The system of claim 1, further caused to provide to the mobile device for display a second interface format following the display of the version.

9. The system of claim 8, wherein the display of the second interface format is provided in reaction to a recognition by the system of a user gesture.

10. The system of claim 1, wherein the interface format includes a branding theme and a private group of users.

11. A method comprising:
receiving from a mobile device identification of an interface format from which a camera view is opened in the mobile device;
identifying a trigger within the camera view for launching one version of an augmented reality experience;
identifying, from the plurality of versions of the augmented reality experience, the one version that uniquely corresponds to the interface format;
providing to the mobile device for display the one version.

12. The method of claim 11, further including receiving from the mobile device a location, wherein the one version uniquely corresponds to both the interface format and the location.

13. The method of claim 12, wherein the location is a position within a virtual perimeter.

14. The method of claim 12, wherein the location is a distance below a threshold proximity to a beacon.

15. The method of claim 12, wherein the trigger is a time or score of a scoreboard at a sporting event.

16. The method of claim 11, further including receiving from the mobile device a user quality of a user operating the mobile device, wherein the one version uniquely corresponds to both the interface format and the user quality.

17. The method of claim 11, further including:
receiving instructions to enable launch of the one version using a second trigger when the second trigger is identified; and
identifying the second trigger and providing the one version to the mobile device for display.

18. The method of claim 11, further including providing to the mobile device for display a second interface format following the display of the version.

19. The method of claim 18, wherein the display of the second interface format is provided in reaction to a recognition by the system of a user gesture.

20. The method of claim 11, wherein the interface format includes a branding theme and a private group of users.
